(19) United States
(12) Patent Application Publication
(10) Pub. No.: US 2025/0299278 A1
(43) Pub. Date: Sep. 25, 2025

(54) SYNTHETIC IMAGE GENERATION USING A CONTEXT-SEMANTIC GUIDED DIFFUSION APPROACH

(71) Applicant: GE Precision Healthcare LLC, Waukesha, WI (US)

(72) Inventors: Nati Daniel, Haifa (IL); Elay Dahan, Ramat Gan (IL); Hedda Cohen Indelman, Haifa (IL); Doron Shaked, Kiryat Tivon (IL); Gopal Avinash, Concord, CA (US); Angeles M. Perez-Agosto, Austin, TX (US); Carmit Shiran, Middleton, WI (US)

(73) Assignee: GE Precision Healthcare LLC, Waukesha, WI (US)

(21) Appl. No.: 19/084,525

(22) Filed: Mar. 19, 2025

Related U.S. Application Data
(60) Provisional application No. 63/567,748, filed on Mar. 20, 2024.

(51) Int. Cl. G06T 1/00

(52) U.S. Cl. CPC G06T 1/00; G06T 2207/20084; G06T 2207/30004

(57) ABSTRACT

Systems and methods for providing a context-semantic guided diffusion approach in medical image generation are described herein. In one example, a system includes a processing circuit having a processor coupled to a memory device. The memory device stores instructions thereon that, when executed, cause the processing circuit to perform operations including generating a semantic mask representing an anatomical structure; identifying a contextual image having the at least one textural feature; and applying the semantic mask and the contextual image to an artificial intelligence model. The artificial intelligence model is configured to generate a synthetic image having the anatomical structure and the at least one textural feature.

### CROSS-REFERENCE TO RELATED PATENT APPLICATIONS

This application claims the benefit of and priority to U.S. Provisional Patent Application No. 63/567,748, filed Mar. 20, 2024, which is incorporated herein by reference in its entirety and for all purposes.

### FIELD

Embodiments of the subject matter disclosed herein relate to medical imaging, and more particularly, to providing a context-semantic guided diffusion approach in medical image generation.

### BACKGROUND

During a medical imaging process, a plurality of medical images of a patient are obtained by a technician to measure or detect various aspects of anatomical features present within the medical images. Furthermore, many image analysis techniques and diagnostic decision support systems used during the medical imaging process implement artificial intelligence (AI) and machine learning (ML).

### SUMMARY

An embodiment relates to a system. The system includes a processing circuit having a processor coupled to a memory device. The memory device stores instructions thereon that, when executed, cause the processing circuit to perform operations. The operations include generating a semantic mask representing an anatomical structure. The operations include identifying a contextual image having at least one textural feature. The operations include applying the semantic mask and the contextual image to an artificial intelligence model, where the artificial intelligence model is configured to generate a synthetic image having the anatomical structure and the at least one textural feature.

Another embodiment relates to a system. The system includes a mask generation network configured to generate a semantic mask representing an anatomical structure. The system includes a context selection network configured to select a contextual image having at least one textural feature. The system includes an image generation network configured to generate a synthetic image having the anatomical structure and the at least one textural feature.

Another embodiment relates to a method. The method includes generating, by a mask generation network, a semantic mask representing an anatomical structure. The method includes identifying, by a context selection network, a contextual image having at least one textural feature. The method includes generating, by an image generation network and in response to receiving the semantic mask and the contextual image as inputs, a synthetic image having the anatomical structure and the at least one textural feature.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a is a block diagram of a medical imaging system, according to an example embodiment.

FIG. 2 is a block diagram of an artificial intelligence (AI) system of the medical imaging system of FIG. 1, according to an example embodiment.

FIG. 3A is a first diagram illustrating synthetic image generation, according to an example embodiment.

FIG. 3B is another diagram illustrating synthetic image generation, according to an example embodiment.

FIG. 4A is an illustration of a first semantic mask, according to an example embodiment.

FIG. 4B is an illustration of a second semantic mask, according to an example embodiment.

FIG. 4C is an illustration of a third semantic mask, according to an example embodiment.

FIG. 5A is an illustration of a first query image, according to an example embodiment.

FIG. 5B is an illustration of a first contextual image selected based on the first query image of FIG. 5A, according to an example embodiment.

FIG. 5C is an illustration of a second query image, according to an example embodiment.

FIG. 5D is an illustration of a second contextual image selected based on the second query image of FIG. 5C, according to an example embodiment.

FIG. 6A is an illustration of a first synthetic image generated based on a semantic mask and a contextual image, according to an example embodiment.

FIG. 6B is an illustration of a second synthetic image generated based on a semantic mask and a contextual image, according to an example embodiment.

FIG. 6C is an illustration of a third synthetic image generated based on a semantic mask and a contextual image, according to an example embodiment.

FIG. 7A is a diagram illustrating generation of the first synthetic image of FIG. 6A using mask augmentations, according to an example embodiment.

FIG. 7B is a diagram illustrating generation of the first synthetic image of FIG. 6A using image augmentations, according to an example embodiment.

FIG. 8 is a flow chart illustrating a method for generating medical images using a context-semantic guided approach, according to an example embodiment.

### DETAILED DESCRIPTION

Referring generally to the figures, systems and methods for a context-semantic guided approach to synthetic image generation are disclosed. More specifically, the systems and methods described herein include receiving semantic masks representative of anatomical structures, selecting contextual images having specific textural features, and generating synthetic images based on the semantic masks and the contextual images, such that the synthetic images have the anatomical structures and the specific textural features.

Despite the prevalence of artificial intelligence (AI) and machine learning (ML) systems used in the medical imaging field, such systems demand a significant amount of data, which can be a limitation of AI- and ML-based medical imaging techniques. Therefore, in existing medical imaging systems, AI and ML solutions are difficult to implement due to the demand of considerable amounts of curated data and, at the same time, the limited availability of diverse, unbiased, and representative training data for such solutions.

To address the challenges above, some systems use synthetic images, which contribute to the enhancement and validation of AI algorithms by supplementing existing datasets. That is, while classical AI approaches are model-centered, these emerging approaches that utilize synthetic images highlight the equal importance of data optimization to model optimization. The emphasis on data optimization is particularly beneficial in instances near the decisions boundaries, in instances of rare examples, and in instances of biased data.

To address the shortage of diverse and comprehensive datasets, the integration of synthetic image generation in such systems can be a promising solution. Among the various techniques to generate synthetic images, any number of artificial intelligence systems can be used, such as generative adversarial networks (GANs) and diffusion models (DMs). However, there are limitations for using these artificial intelligence systems. For example, Image Translation GANs may be used to create synthetic images based on synthetic labels, though scalability can be constrained if semantic labels are limited. Vanilla GANs lack semantic information, but offer the capability to generate an unlimited array of synthetic images.

In other words, while GANs and DMs are scalable due to their sampling process, controlling their generative semantics is limited. Although semantic mask guidance may be applied to overcome the challenges associated with medical image synthesis, there remains a gap when applying these models to the generation of synthetic images, as the semantic masks fail to represent textural information of medical images. Thus, the effectiveness of using semantic mask guidance to create diverse and representative datasets is constrained.

Furthermore, effective data augmentation is a technique that may be used to improve the performance of modern medical image deep networks. Augmentations that lack semantic knowledge, however, are unable to generate high diversity and representation of the training set and test set. Other augmentations may improve the fidelity of synthetic images, but have a limited scalability because they depend on a limited amount of semantic information from real images for inference. Similarly, an advanced two-stage AI solution for generating semantic information for high-fidelity RGB (red, green, blue) images suffers from bounded scalability, as such a solution generates images with a similar distribution to the distribution on which the model is trained. Therefore, these solutions are constrained in improving downstream performance, especially in rare cases of medical conditions characterized by rare samples.

In response to the gaps present in existing solutions, the systems and methods described herein provide an innovative fusion solution by employing a state-of-the-art conditional latent diffusion model architecture, where the input to the denoising U-Net is modified such that the denoising U-Net is enabled to process two images. The first image, infused with semantic guidance, provides for control over anatomical structure, ensuring precision in the geometry of the output image. To further enhance the diversity of generated samples, the solution described herein incorporates a second image with context guidance, enriching the texture of synthesized medical images. By introducing context and semantic guidance, the end-to-end approach described herein contributes to the advancement of AI applications in the medical imaging domain.

In other words, the systems and methods described herein provide a technical solution to existing systems by introducing a three-stage AI solution for generating synthetic images. More specifically, the three-stage AI solution addresses the quality-scalability-controllability trade-off of existing solutions by providing the ability to control anatomical geometry and textural features of the synthetic image in a precise manner, while preserving the quality of the synthetic image.

The novel method described herein includes an unlimited degree of freedom to automatically generate optimized data augmentation and high-fidelity synthetic data. Moreover, the three-stage AI solution showcases the adeptness to address issues related to biased training datasets and a deficiency in diversity, such as the infrequent occurrence of rare pathological cases, instances with acute implications for treatments, and instances reflecting biased representations within demographic groups. The implementation described herein uses Stable Diffusion and Deep Learning for synthetic sample generation based on prior knowledge (e.g., clinical images or random images).

Furthermore, the systems and methods described herein control an image synthesis process to generate samples such that the downstream model yields high validation accuracy of a target real dataset, while also understanding failure cases. Such systems and methods provide significant improvements in medical image segmentation, and can be effective to any type of machine learning task. Moreover, the systems and methods for synthetic image generation described herein also can be adapted to any common datasets, physical vendor systems, and multiple modalities (e.g., ultrasound, magnetic resonance (MR), X-Ray, computed tomography (CT), etc.).

As mentioned above, the systems and methods described herein are based on the Stable Diffusion approach and Deep Learning. As such, the systems and methods described herein provide effective data augmentation and high-fidelity synthetic data, use prior knowledge to extend variability space, are modality agnostic in support of multiple medical image tasks, can support any type of data from different medical vendors and physical systems, and are configured to understand AI model failure cases.

The implementations described herein address a technical problem by providing enhanced data integration and analysis capabilities, which deliver a particular technical solution that streamlines and refines generation and transmittal of medical images. More specifically, the systems and methods described herein introduce a scalable and controllable generative method that captures anatomical structure, maps a semantic map to texture/scene, and produces clinically realistic, high quality synthetic medical images. By doing so, the systems and methods described herein are configured to generate pathology determinations in varied geometries and textures of anatomy and pathology. Furthermore, the approach to synthetic image generation described herein provides a powerful tool to further generate synthetic images, correcting biases in small datasets, as well as extending and expanding the variability space, increasing algorithm accuracy, and ensuring their reliability. Accordingly, this approach provides a specific technical improvement to various technical problems, including those set forth herein.

The systems described herein may also reduce processing power by performing various processing operations simultaneously, rather than performing a plurality of processing operations individually and consuming unnecessary processing power. That is, the systems and methods described herein result in more efficient model development and improved model performance.

Furthermore, the context-semantic guided approach to synthetic image generation described herein provides various benefits. For instance, this approach enables the development of more efficient, accurate, and reliable AI models for improved diagnoses, especially in rare examples that have acute consequences for treatment and in examples near the decision threshold. Such an approach as described herein also controls the visible distribution of scenarios and extends the variability space, debiases the dataset, and allows for a better diversity and representation of groups or locations reflected in the training set. The development productivity of AI is also improved because the approach described herein provides a solution to data generation where the data is otherwise expensive, difficult to acquire, limited, not free of privacy concerns, or unavailable.

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

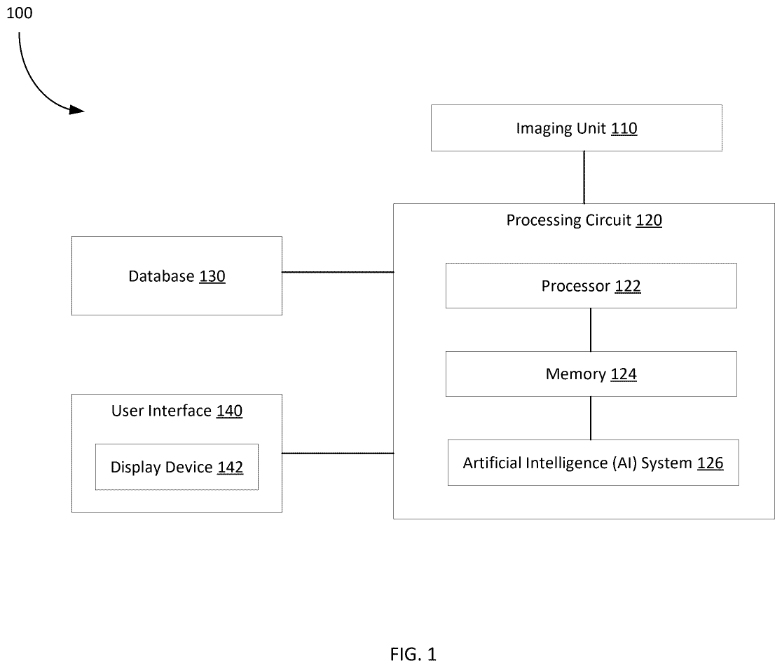

Referring to FIG. 1, a schematic diagram of a medical imaging system 100 is shown. The medical imaging system 100 may be used in a medical environment (e.g., hospitals, clinics, etc.), for example, by a sonographer, radiographer, technician, or other clinician certified to collect medical image data of a patient. It should be appreciated that the medical imaging system 100 described herein may refer to any of a variety of medical imaging systems (e.g., a computed tomography (CT) imaging system, an ultrasound imaging system, a magnetic resonance (MR) imaging system, a positron emission tomography (PET) imaging system, a single-photon emission computerized tomography (SPECT) imaging system, etc.).

For instance, a CT imaging system uses X-rays to generate cross-sectional images of the body. More specifically, an imaging unit (e.g., imaging unit 110) used in the CT imaging system includes an X-ray source positioned around the patient that emits a narrow beam of X-rays through the body from multiple angles. The imaging unit also includes detectors configured to capture the transmitted X-rays that pass through different features (e.g., tissues) in the body, each of the different features absorbing the radiation to varying degrees depending on their density and composition. These signals are then processed by the system to reconstruct a series of two-dimensional slices, which can be stacked to create a three-dimensional representation of the imaged area.

An ultrasound imaging system, as another example, uses high-frequency sound waves to create real-time images of structures inside the body. More specifically, a transducer (e.g., a handheld device) generates the sound waves and directs them into the body. As the sound waves encounter different tissues, they are reflected back to the transducer as echoes at varying intensities based on the density and composition of the tissues. The transducer then converts the echoes into electrical signals, which are processed by the system to produce images displayed on a monitor. Ultrasound is non-invasive, radiation-free, and widely used for various applications, including monitoring pregnancies and examining organs.

An MR imaging system uses magnetic fields and radio waves to create detailed images of the body's internal structures. An MR system first generates a magnetic field that aligns the protons in the hydrogen atoms of the body's tissues. A series of radiofrequency pulses are then applied, causing the protons to absorb energy and shift their alignment. When the pulses stop, the protons release the energy as they return to their original state. The MR imaging system detects and processes these signals to create detailed images, differentiating between various tissue types based on their water content and chemical composition. MR may be used for imaging soft tissues, such as the brain, muscles, and organs, without exposing patients to ionizing radiation.

PET imaging systems are configured to detect gamma rays emitted from a radioactive tracer that is injected into the patient's body. The tracer (e.g., a compound such as glucose labeled with a radioactive isotope) accumulates in areas of high metabolic activity, such as rapidly growing tumors or active brain regions. As the radioactive isotope decays, it emits positrons that collide with electrons in the body, resulting in the emission of two gamma rays traveling in opposite directions. The PET imaging unit detects these gamma rays with a ring of specialized detectors, and the data is processed to reconstruct three-dimensional images, which provide detailed information about the body's biochemical and metabolic processes. In this way, PET imaging systems may be used in oncology, cardiology, and neurology for diagnosing diseases, monitoring treatments, and studying brain function.

Similarly, SPECT imaging systems are also configured to detect gamma rays emitted from a radioactive tracer introduced into the patient's body. The tracer is attached to a molecule that targets specific organs or tissues and emits gamma photons as it decays. An imaging unit in the SPECT imaging systems is equipped with one or more gamma cameras that rotate around the patient and captures the photons from different angles. The system uses the detected signals to reconstruct three-dimensional images of the tracer distribution within the body, showing functional information about organs and tissues. In this way, SPECT imaging systems may be used for assessing blood flow, cardiac function, and bone metabolism, as well as diagnosing conditions such as cancer, infections, and neurological disorders.

Using the MR imaging system as an example, an imaging procedure performing using the medical imaging system 100 may be performed as described in the following. During the procedure, the patient lies on a motorized table that slides into a large, cylindrical imaging unit (e.g., scanner) equipped with magnets. To receive clear images, the patient remains as still as possible throughout the scan. Depending on the area being examined, a contrast agent may be injected into the patient's bloodstream to enhance visibility of certain tissues or blood vessels. The MR imaging system creates the magnetic field and emits radiofrequency pulses, which interact with hydrogen atoms in the patient's body. These interactions generate signals that are processed by the system to produce detailed images of the targeted area. As described above, the MR imaging procedure may be used to diagnose and monitor a wide range of medical conditions such as brain disorders, joint injuries, and tumors.

As shown in FIG. 1, the medical imaging system 100 includes an imaging unit 110, a processing circuit 120, a database 130, and a user interface 140. The imaging unit 110 refers to a device or mechanism configured to obtain image data during a medical imaging procedure using the medical imaging system 100. That is, the imaging unit 110 may include any of a device or a mechanism used to obtain image data during a CT imaging procedure, an ultrasound imaging procedure, an MR imaging procedure, a PET imaging procedure, a SPECT imaging procedure, etc., depending on an implementation of the medical imaging system 100.

Referring still to FIG. 1, the processing circuit 120 is shown to include at least one processor 122, a memory 124, and an artificial intelligence (AI) system 126. In this way, the processing circuit 120 may be structured or configured to execute or implement the instructions, commands, and control processes described herein with respect to the processor 122, the memory 124, and the AI system 126. While shown as being separate from the imaging unit 110 in FIG. 1, it will be appreciated that the processing circuit 120 can be part of the imaging unit 110. For example, the processing circuit 120 can be disposed in a handheld housing of a probe (e.g., in the case of the imaging unit 110 being a wireless probe).

The processor 122 may include a CPU, a GPU, a microprocessor, a DSP, a general-purpose single- or multi-chip processor, a field-programmable gate array (FPGA), or any other type of processor capable of performing logical operations. A general-purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the processor 122 may be shared by multiple circuits (e.g., the circuits of the processor 122 may include or otherwise share the same processor which, in some example embodiments, may execute instructions stored, or otherwise accessed, via different areas of the memory 124). Alternatively or additionally, the processor 122 may be structured to perform or otherwise execute certain operations independent of one or more co-processors. In some embodiments, two or more processors may be coupled via a bus to enable independent, parallel, pipelined, or multi-threaded instruction execution. All such variations are intended to fall within the scope of the present disclosure.

The processor 122 may also be in electronic communication with the imaging unit 110. For purposes of this disclosure, the term “electronic communication” may be defined to include both wired and wireless communications. In some embodiments, the processor 122 may be configured to control the imaging unit 110 during data acquisition. The processor 122 may also be in electronic communication with a display device (e.g., display device 142) such that the processor 122 may process medical image data obtained by the imaging unit 110 and generate images to display on the display device. Further, in some embodiments, the medical imaging system 100 may include multiple processors configured to perform the processing operations and functionality described with reference to processor 122.

As shown in FIG. 1, the processing circuit 120 also includes the memory 124. The memory 124 may be configured to, for example, store processed volumes of data obtained by the medical imaging system 100 (e.g., image data collected by the imaging unit 110, user inputs received via user interface 140, etc.). For example, the memory 124 may be a hospital picture archiving and communication system (PACS). The memory 124 (e.g., memory, memory unit, storage device, etc.) may include one or more devices (e.g., RAM, ROM, Flash memory, hard disk storage, etc.) for storing data and computer code for completing or facilitating the processes, layers, and modules described in the present application. The memory 124 may be or include tangible, non-transient volatile memory or non-volatile memory. The memory 124 may also include database components, object code components, script components, or any other type of information structure for supporting the activities and information structures described in the present application.

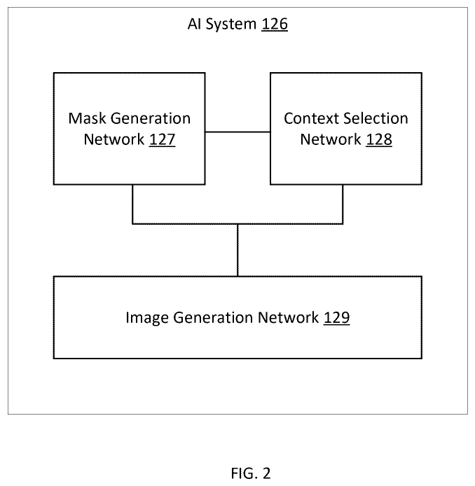

The processing circuit 120 is also shown to include the AI system 126. The AI system 126 is configured to provide a context-semantic guided diffusion approach to image generation, as described herein. The AI system 126 is described in greater detail below with reference to FIG. 2.

As shown in FIG. 1, the medical imaging system 100 may also include a database 130 and a user interface 140. The database 130 refers to a database from which the processing circuit 120 (e.g., the AI system 126) may retrieve information (e.g., medical image data) used to provide a context-semantic guided diffusion approach to image generation, as described herein. In some instances, the database 230 may be configured to store synthetic medical images generated by the AI system 126, as described herein, for downstream use.

The user interface 140 may be used by a technician to control operation of the medical imaging system 100. For example, the technician may use the user interface 140 to control the input of patient data, to change a scanning or display parameter, and/or to select various other modes, operations, parameters, etc. of the medical imaging system 100. In some embodiments, the user interface 140 may include an off-the-shelf consumer electronic device such as a smartphone, a tablet, a laptop, and so on. For the purposes of this disclosure, the term “off-the-shelf consumer electronic device” is defined to be an electronic device that was designed and developed for general consumer use and one that was not specifically designed for use in a medical environment. Alternatively, in other embodiments, the user interface 140 may be an electronic device that was designed and developed for use in a medical environment.

According to some embodiments, the user interface 140 may be physically separate from the rest of the medical imaging system 100 (e.g., the imaging unit 110, the processing circuit 120, and/or the database 130). The user interface 140 may communicate with the processor 122 through a wireless protocol, such as Wi-Fi, Bluetooth, wireless local area network (WLAN), near-field communication, and so on. According to some embodiments, the user interface 140 may communicate with the processor 122 through an application programming interface (API).

In some embodiments, the user interface 140 may include physical controls such as one or more of buttons, sliders, a rotary knob, a mouse, a keyboard, a trackball, hard keys linked to specific actions, soft keys that may be configured to control different functions, and so on. As shown in FIG. 1, the user interface 140 may also include a display device 142. In some embodiments, the display device 142 may be configured to display a graphical user interface (GUI) based on an instruction from the memory 124. The GUI may include user interface icons representing commands and instructions relating to the operation of the medical imaging system 100. The user interface icons of the GUI may be configured such that a user (e.g., technician, clinician, etc.) may select a specific user interface icon in order to initiate a specific function controlled by the GUI. For example, various user interface icons may be used to represent windows, menus, buttons, cursors, scroll bars, and so on. That is, the physical controls of the user interface 140 may be included as individual hardware elements, as user interface icons displayed on the display device 142, or as a combination of hardware elements and user interface icons.

In some embodiments, the display device 142 may include a touch-sensitive display device or a touch screen. According to such embodiments, the touch screen may be configured to interact with the GUI displayed by the display device 142 such that a user (e.g., the technician) can interact with the GUI via the touch screen. The touch screen may be a single-point touch screen that is configured to detect a single contact point at a time, or the touch screen may be a multi-point touch screen that is configured to detect multiple points of contact at a time. For embodiments where the touch screen is a multi-point touch screen, the touch screen may be configured to detect multi-point gestures involving contact from two or more of a user's fingers at a time. The touch screen may be a resistive touch screen, a capacitive touch screen, or any other type of touch screen that is configured to receive inputs from a stylus or one or more of a user's fingers. According to some embodiments, the touch screen may be an optical touch screen that uses technology such as infrared light or other frequencies of light to detect one or more points of contact initiated by a user. In some embodiments, the touch screen may be incorporated as part of the display device 142 or may be separate from the display device 142.

Referring to FIG. 2, the AI system 126 of the medical imaging system 100 is shown in greater detail. More specifically, the AI system 126 is shown to include a mask generation network 127, a context selection network 128, and an image generation network 129. Each of the mask generation network 127, the context selection network 128, and the image generation network 129 are configured to provide the context-semantic guided approach to synthetic image generation, as described herein. While the mask generation network 127, the context selection network 128, and the image generation network 129 are shown as being part of the AI system 126, it will be appreciated that in some embodiments one or more of the mask generation network 127, the context selection network 128, or the image generation network 129 are not neural networks or do not employ the use of artificial intelligence or machine learning to carry out its functions and the corresponding functions can be performed using other hardware and software processes disclosed here.

In some instances, a first phase of the approach to providing context-semantic guidance described herein includes deriving the mask generation network 127. More specifically, the mask generation network 127 is trained to learn the internal geometry of digitized medical images and express the internal geometry by a semantic mask (e.g., semantic mask 210). As such, the mask generation network 127 is configured to generate semantic masks (e.g., semantic mask 210) during the context-semantic guided approach to synthetic image generation. For example, the mask generation network 127 may be configured to generate a semantic mask from noise (e.g., noise 201). In some embodiments, the mask generation network 127 may be trained using a plurality of mask images.

In some instances, a second step of the approach to providing context-semantic guidance described herein includes deriving the context selection network 128. More specifically, the context selection network 128 controls the internal texture of generated medical images. In this way, the context selection network 128 is configured to identify contextual images (e.g., contextual image 220) during the context-semantic guided approach to synthetic image generation. For example, the context selection network 128 may be configured to identify a contextual image having at least one textural feature. In some embodiments, the context selection network 128 may be trained using natural images.

A third step of the approach to providing context-semantic guidance described herein may include deriving the image generation network 129. More specifically, the image generation network 129 refers to an image translation task configured to transfer both a discrete semantic mask (e.g., from the mask generation network 127) and a context image (e.g., from the context selection network 128) to a clinically realistic RGB medical image. In other words, the image generation network 129 refers to an artificial intelligence model that is configured to generate synthetic images (e.g., synthetic image 230) during the context-semantic guided approach to synthetic image generation. For example, the image generation network 129 may be configured to generate a synthetic image having the anatomical structure of a semantic mask and the textural features of a contextual image. That is, the image generation network 129 is configured to receive, as inputs, a semantic mask (e.g., semantic mask 210) from the mask generation network 127 and a contextual image (e.g., contextual image 220) from the context selection network 128. Then, the image generation network 129 is configured to generate a synthetic image depicting the anatomical structure of the semantic mask and having the textural features of the contextual image.

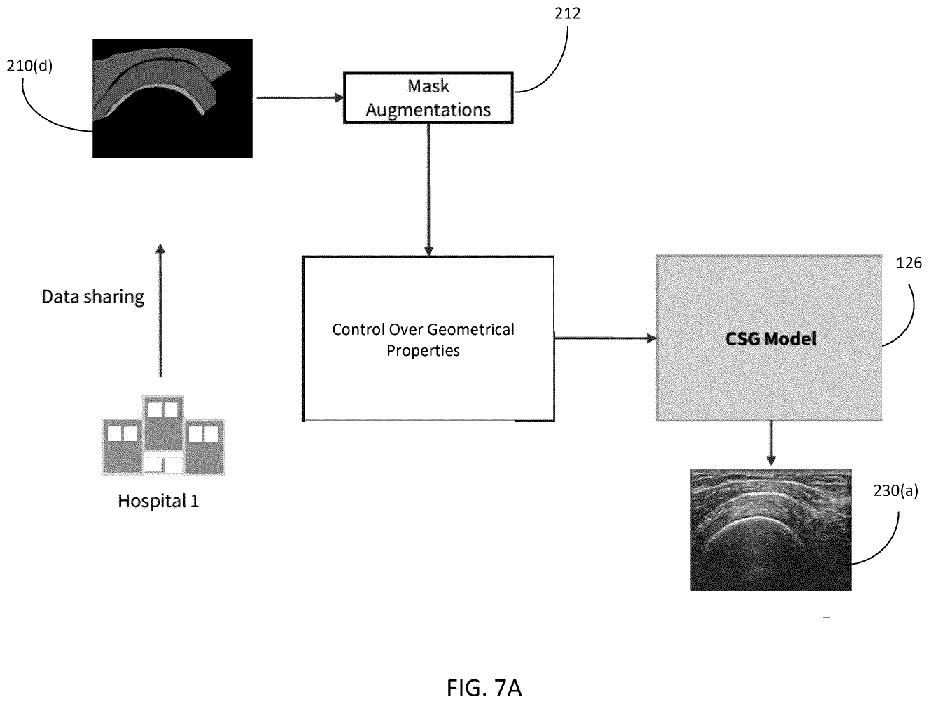

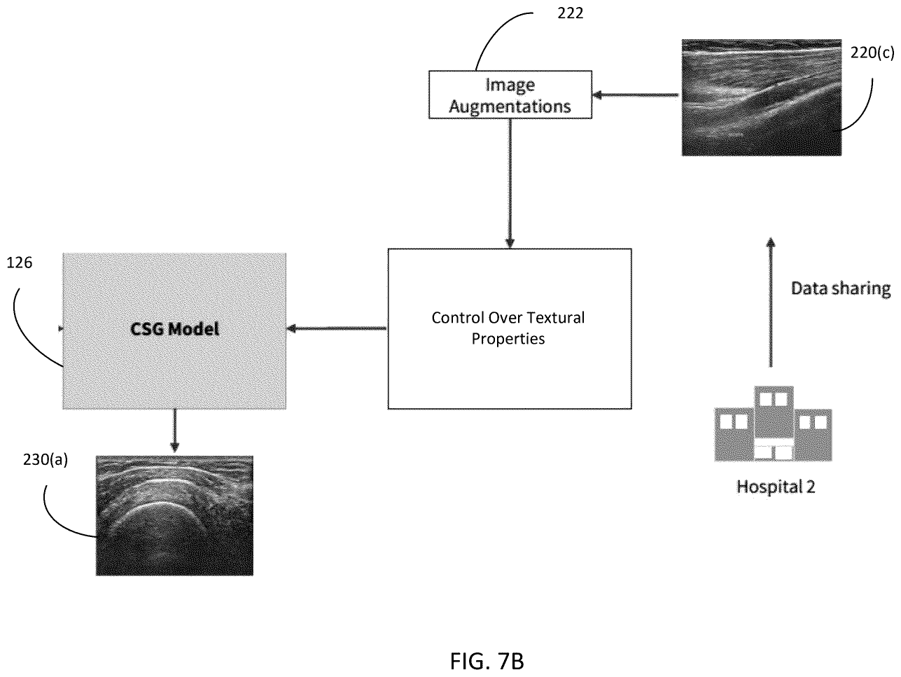

Furthermore, in some instances, the image generation network 129 is configured to apply an augmentation prior to generation of the synthetic image. For instance, the image generation network 129 may apply a mask augmentation (e.g., mask augmentation 212, as shown in FIG. 7A) to the semantic mask received as an input from the mask generation network 127 prior to generating the synthetic image. Additionally or alternatively, the image generation network 129 may apply an image augmentation (e.g., image augmentation 222, as shown in FIG. 7B) to the contextual image received as an input from the context selection network 128 prior to generating the synthetic image. In some embodiments, the image generation network 129 may include a paired image translation diffusion model.

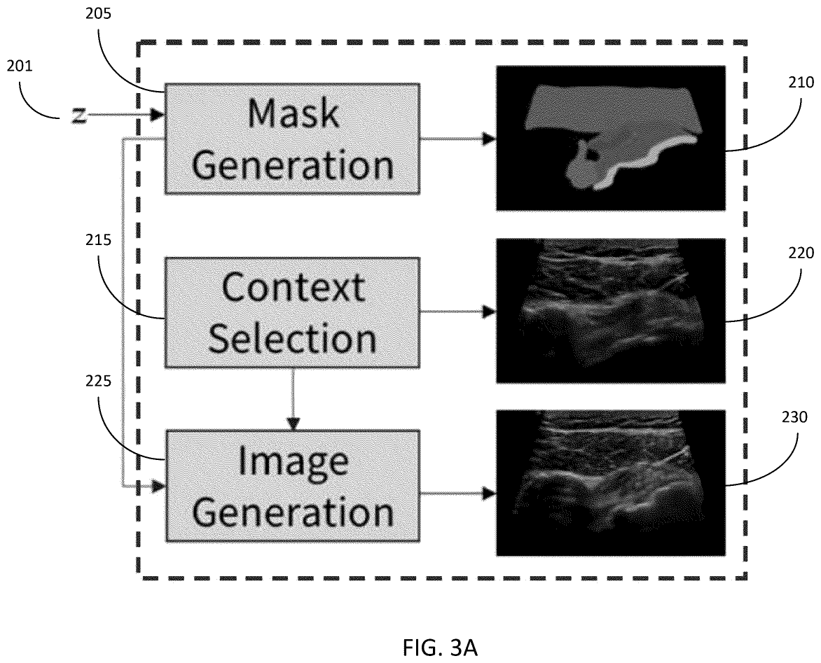

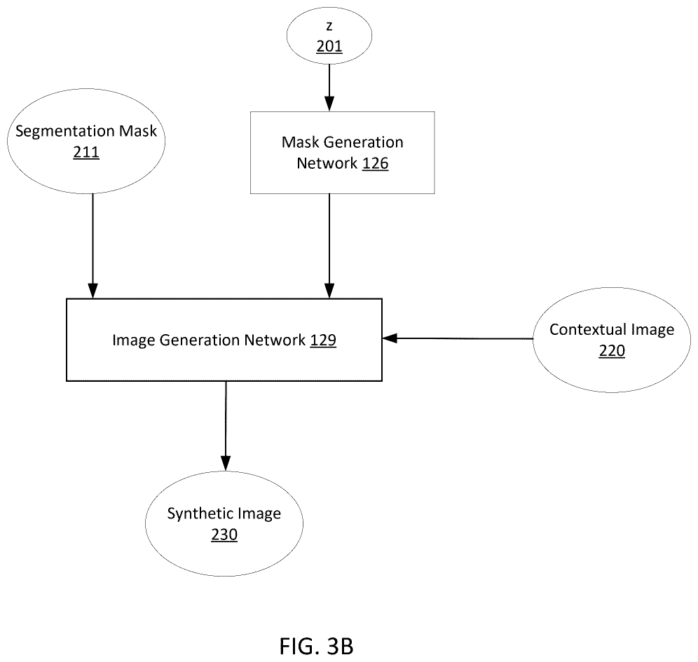

Referring to FIG. 3A, a diagram illustrating synthetic image generation using the AI system 126 of FIG. 2 is shown. That is, FIG. 3A depicts the triple-phase generative system used to provide the context-semantic guidance described herein. In an example implementation of the triple-phase generative system shown in FIG. 3A, the initial step (e.g., mask generation 205) includes generating semantic masks (e.g., semantic mask 210) of musculoskeletal (MSK) labels using a fine-tuned StyleGAN architecture from noise 201 (e.g., z). Subsequently (e.g., during context selection 215), contextually similar images (e.g., contextual image 220) are selected using a neural algorithm of artistic style. Then (e.g., during image generation 225), the generated masks and contexts undergo processing through a paired image translation diffusion model to yield a synthetic ultrasound image (e.g., synthetic image 230). This approach harmonizes the advantages of semantic guidance and unlimited unbiased image generation.

More specifically, the synthetic image generation is shown to include mask generation 205 of a semantic mask 210. The semantic mask 210 may be generated by the mask generation network 127, as described above. In an example implementation, the mask generation network 127 may utilize StyleGAN-V2 to provide a generative model pretrained on the BRECAHAD dataset, is fine-tuned on ultrasound mask images. Such an adaptation may include training the StyleGAN model on all training set masks. Furthermore, to facilitate segmenting pathology findings during the medical imaging process, the mask generation network 127 may implement a filtering mechanism to exclude generated masks lacking significant pathology areas.

The synthetic image generation is also shown to include context selection 215 of a contextual image 220. The contextual image 220 may be selected by the context selection network 128, as described above. In some instances, the context-based selection approach is based on translating a semantic map (e.g., semantic mask 210) to its corresponding texture. In some embodiments, training such a model (e.g., the context selection network 128) utilizes a dataset of paired semantic masks and images. Furthermore, to control the textural properties of the output images, context conditioning is introduced. Context guidance is achieved by identifying a similar image in terms of visual properties to the target image within the dataset. Consequently, from the pool of training images, the image with the most similar stylistic features, as determined by the closest non-equal vector in terms of Mean Squared Error (MSE), is queried to construct the dataset.

Then, the semantic mask 210 and the contextual image 220 are used as inputs for image generation 225 of a synthetic image 230. The synthetic image 230 may be generated by the image generation network 129, as described above. In some instances, the image generation 225 may be based on the conditional latent diffusion model architecture pretrained on LAION-400M, which is primarily employed for text-to-image translation based on stable diffusion technology. The model receives two input images (e.g., the semantic mask 210 and the contextual image 220) and generates a single output image (e.g., synthetic image 230). This process of receiving two inputs to generate a single output involves adjusting the input of the denoising U-Net to accommodate two images. The sampling score estimation is presented as

$$( {z}_{t} , {c}_{T} , {c}_{C} ) = ∅ + {s}_{S} ( {e}_{θ} ( {z}_{t} , {c}_{S} , ∅ ) - ∅ ) + {s}_{c} ( {e}_{θ} ( {z}_{t} , {c}_{S} , {c}_{C} ) - {e}_{θ} ( {z}_{t} , {c}_{S} , ∅ ) ) \qquad ( 1 )$$

where Ø denotes the following expression, e_{θ} (zₜ, Ø, Ø), C indicates the context guidance, and s_{S}=1.5 and s_{C}=2.5.

Thus, with semantic guidance, precise control over the anatomical structure (geometry) of the output image (e.g., synthetic image 230) is achieved. Context (e.g., textural) guidance is incorporate to enhance the diversity of generated samples. Further, during inference, the image generation network 129 maps a pair of a semantic map and texture to a medical image (e.g., an ultrasound image) that aligns with both the geometry of the semantic mask 210 and the texture of the contextual image 220.

Referring to FIG. 3B, another diagram illustrating the synthetic image generation using the AI system 126 of FIG. 2 is shown. That is, FIG. 3B depicts the image generation network 129 generating the synthetic image 230 in response to receiving the contextual image 220 (e.g., a contextual clinical image) and a semantic mask. As shown in FIG. 3B, the image generation network 129 may receive the semantic mask (e.g., semantic mask 210) from the mask generation network 126 based on the noise 201. Additionally or alternatively, the image generation network 129 may receive a segmentation mask 211. The segmentation mask refers to a semantic mask (e.g., semantic mask 210) generated by a segmentation model on a medical image. In some instances, the image generation network 129 may not receive the contextual image 220, in which case the textural features of the synthetic image 130 may be random.

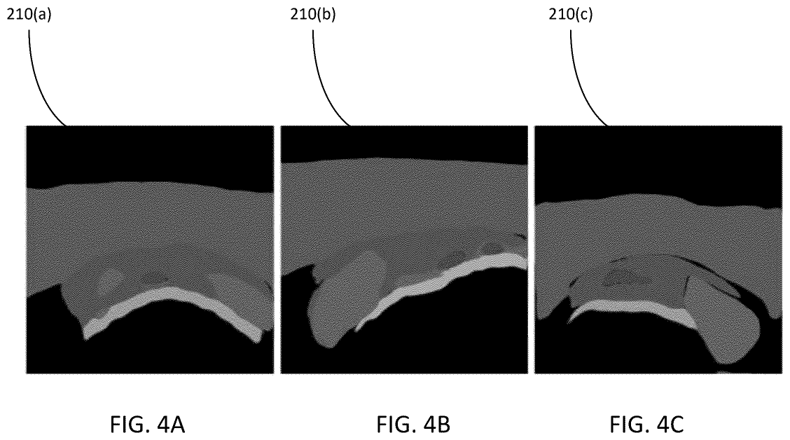

Referring to FIGS. 4A-4C, semantic masks 210(a), 210(b), and 210(c) are shown, respectively. That is, semantic masks 210(a), 210(b), and 210(c) may be examples of the semantic mask 210 generated by the mask generation network 127 during the mask generation 205 of FIG. 3A. In some instances, the semantic masks 210(a), 210(b), and 210(c) depict anatomical features such as muscle, tendons, calcification, discontinuities in tendon fiber, bones, anisotropy, bone irregularity, etc. using visual indicators such as a predefined coloring scheme.

As shown in FIGS. 4A-4C, each of the semantic masks 210(a), 210(b), and 210(c) depict one or more anatomical structures. More specifically, each of the semantic masks 210(a), 210(b), and 210(c) may be generated such that the semantic masks 210(a), 210(b), and 210(c) depict one or more anatomical structures depicted in a corresponding query image (e.g., query image 200(a), 200(b)).

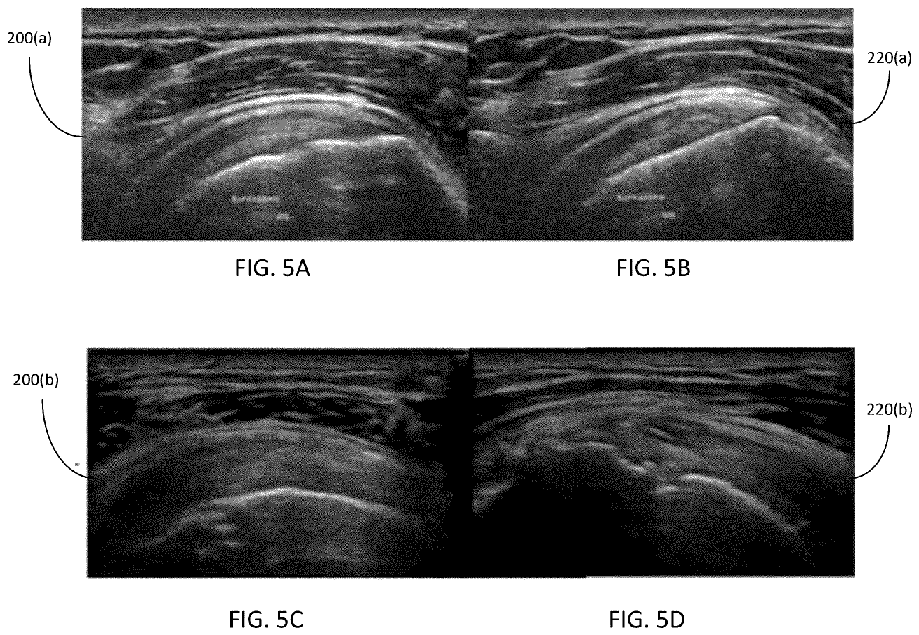

Referring to FIG. 5A, a query image 200(a) received by the AI system 126 is shown. The query image 200(a) may be a medical image obtained by the medical imaging system 100 (e.g., the imaging unit 110). Additionally or alternatively, the query image 200(a) may be retrieved from the database 130. Furthermore, as shown in FIG. 5A, the query image 200(a) may depict an anatomical structure, and the query image 200(a) may have one or more textural features (e.g., a brightness, a contrast, a granularity, etc.).

FIG. 5B shows a contextual image 220(a) selected by the AI system 126 based on the query image 200(a). That is, the contextual image 220(a) may be an example of the contextual image 220 selected by the context selection network 128 during the context selection 215 of FIG. 3A. As shown in FIG. 5B, the contextual image 220(a) may have the one or more textural features (e.g., the brightness, the contrast, the granularity, etc.) of the query image 200(a).

Referring to FIG. 5C, a query image 200(b) received by the AI system 126 is shown. The query image 200(b) may be a medical image obtained by the medical imaging system 100 (e.g., the imaging unit 110). Additionally or alternatively, the query image 200(b) may be retrieved from the database 130. Furthermore, as shown in FIG. 5C, the query image 200(b) may depict an anatomical structure, and the query image 200(b) may have one or more textural features (e.g., a brightness, a contrast, a granularity, etc.).

FIG. 5D shows a contextual image 220(b) selected by the AI system 126 based on the query image 200(b). That is, the contextual image 220(b) may be an example of the contextual image 220 selected by the context selection network 128 during the context selection 215 of FIG. 3A. As shown in FIG. 5D, the contextual image 220(b) may have the one or more textural features (e.g., the brightness, the contrast, the granularity, etc.) of the query image 200(b).

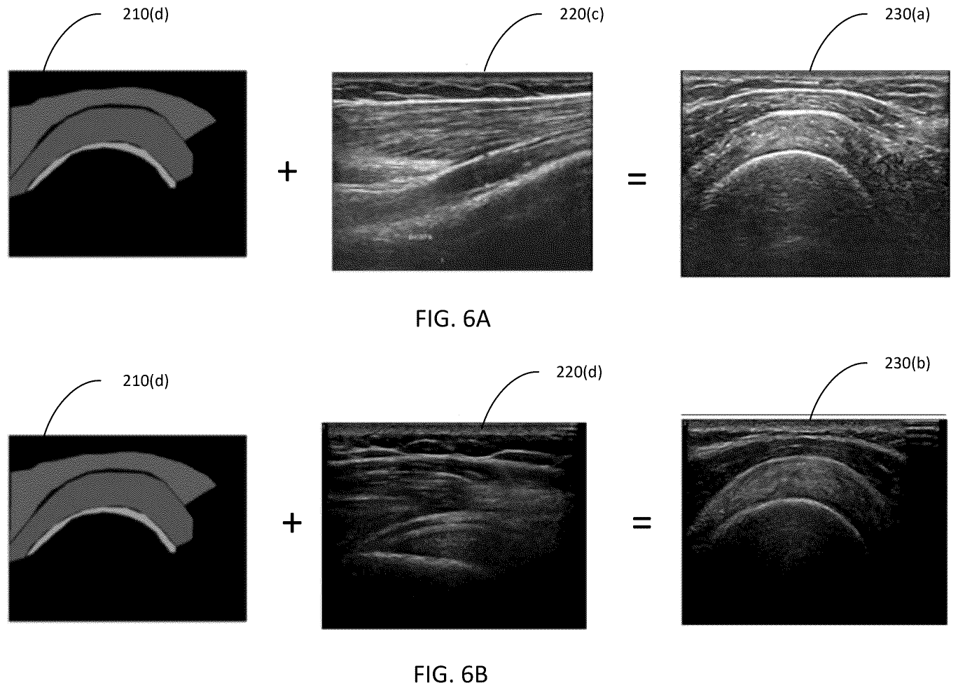

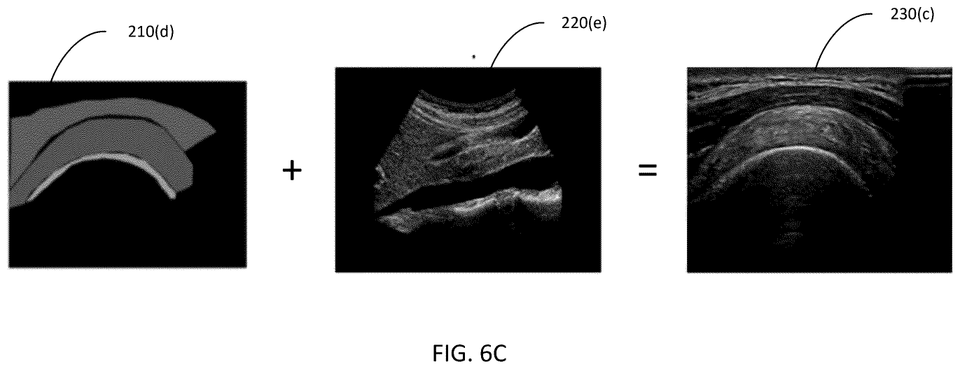

Referring to FIG. 6A, a synthetic image 230(a) generated by the AI system 126 using the context-semantic guided approach to synthetic image generation is shown. That is, the synthetic image 230(a) may be an example of the synthetic image 230 generated by the image generation network 129 during the image generation 225 of FIG. 3A. As shown in FIG. 6A, the synthetic image 230(a) may be generated by the image generation network 129 based on a semantic mask 210(d) (e.g., generated by the mask generation network 127 during the mask generation 205 of FIG. 3A) and based on a contextual image 220(c) (e.g., generated by the context selection network 128 during the context selection 215 of FIG. 3A). In other words, the synthetic image 230(a) shown in FIG. 6A has the anatomical structure represented by the semantic mask 210(d) and has the textural features of the contextual image 220(c).

Referring to FIG. 6B, a synthetic image 230(b) generated by the AI system 126 using the context-semantic guided approach to synthetic image generation is shown. That is, the synthetic image 230(b) may be an example of the synthetic image 230 generated by the image generation network 129 during the image generation 225 of FIG. 3A. As shown in FIG. 6B, the synthetic image 230(b) may be generated by the image generation network 129 based on a semantic mask 210(d) (e.g., generated by the mask generation network 127 during the mask generation 205 of FIG. 3A) and based on a contextual image 220(d) (e.g., generated by the context selection network 128 during the context selection 215 of FIG. 3A). In other words, the synthetic image 230(b) shown in FIG. 6B has the anatomical structure represented by the semantic mask 210(d) and has the textural features of the contextual image 220(d).

Referring to FIG. 6C, a synthetic image 230(c) generated by the AI system 126 using the context-semantic guided approach to synthetic image generation is shown. That is, the synthetic image 230(c) may be an example of the synthetic image 230 generated by the image generation network 129 during the image generation 225 of FIG. 3A.

As shown in FIG. 6C, the synthetic image 230(c) may be generated by the image generation network 129 based on a semantic mask 210(d) (e.g., generated by the mask generation network 127 during the mask generation 205 of FIG. 3A) and based on a contextual image 220(e) (e.g., generated by the context selection network 128 during the context selection 215 of FIG. 3A). In other words, the synthetic image 230(c) shown in FIG. 6C has the anatomical structure represented by the semantic mask 210(d) and has the textural features of the contextual image 220(e).

In sum, FIGS. 6A-6C are shown to demonstrate how the same semantic mask (e.g., semantic mask 210(d)) can be used by the image generation network 129 to generate a plurality of synthetic images (e.g., synthetic image 230(a), synthetic image 230(b), synthetic image 230(c), etc.) having distinct textural features based on a plurality of distinct contextual images (e.g., contextual image 220(c), contextual image 220(d), contextual image 220(c)).

Referring to FIGS. 7A and 7B, a diagram illustrating generation of the synthetic image 230(a) of FIG. 6A using augmentations is shown. More specifically, FIG. 7A shows generation of the synthetic image 230(a) using mask augmentations 212 applied to the semantic mask 210(d), and FIG. 7B shows generation of the synthetic image 230(b) using image augmentations 222 applied to the contextual image 220(c).

FIG. 7A shows the semantic mask 210(d) generated by the mask generation network 127 using data sharing (e.g., data from hospital 1). Then, the mask augmentations 212 are applied to the semantic mask 210(d). The mask augmentations 212 may be used to control geometrical properties of the semantic mask 210(d). For instance, the mask augmentations 212 may be used to control at least one of a shape, a width, a size, or an image orientation of the semantic mask 210(d). In some instances, the mask augmentations 212 may be applied to the semantic mask 210(d) based on a patient anatomy. For example, the mask augmentations 212 may be applied to address a patient-specific muscle width, a patient-specific tendon mass, etc. Then, the semantic mask 210(d) with the mask augmentations 212 is applied as an input to the AI system 126 (e.g., the image generation network 129). As shown in FIG. 7A, the AI system 126 (e.g., the image generation network 129) generates the synthetic image 230(a) based on the semantic mask 210(d) and the mask augmentations 212.

FIG. 7B shows the contextual image 220(c) selected by the context selection network 128 using data sharing (e.g., data from hospital 2). Then, the image augmentations 222 are applied to the contextual image 220(c). The image augmentations 222 may be used to control textural properties of the contextual image 220(c). For instance, the image augmentations 222 may be used to control at least one of a contrast, a granularity, or a brightness of the contextual image 220(c). In some instances, the image augmentations 222 may be applied to the contextual image 220(c) based on a system parameter. For example, the image augmentations 222 may be applied to account for the textual effects of a specific probe used to obtain medical image data, an overall quality of an imaging system used to obtain medical image data, etc. Then, the contextual image 220(c) with the image augmentations 222 is applied as an input to the AI system 126 (e.g., the image generation network 129). As shown in FIG. 7B, the AI system 126 (e.g., the image generation network 129) generates the synthetic image 230(a) based on the contextual image 220(c) and the image augmentations 222.

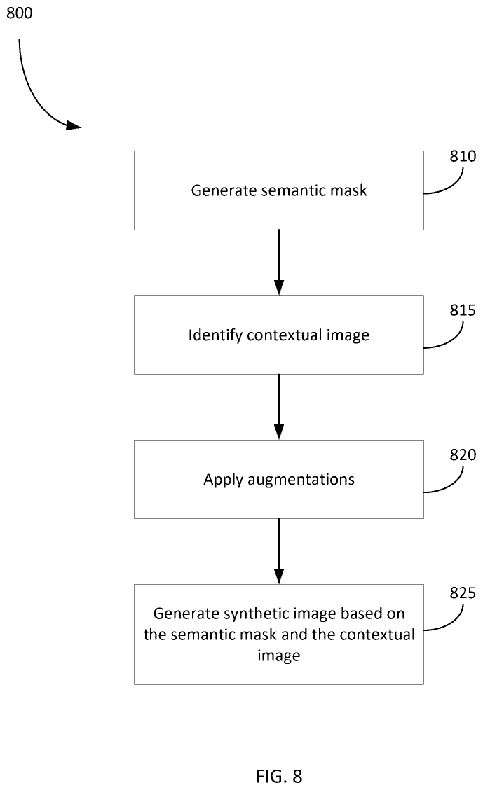

Referring to FIG. 8, a flow chart illustrating a method 800 for generating medical images using a context-semantic guided approach is shown. In at least one embodiment, the medical imaging system referred to by method 800 is the medical imaging system 100 described above with reference to FIG. 1, and method 800 may be implemented by the medical imaging system 100. More specifically, method 800 may be implemented by the AI system 126 of the medical imaging system 100 (e.g., as shown in FIG. 2). In some embodiments, method 800 may be implemented as executable instructions in a memory of the medical imaging system 100, such as the memory 124 of FIG. 1.

As shown in FIG. 8, step 810 includes generating a semantic mask. That is, the semantic mask generated at step 810 is generated such that the semantic mask represents an anatomical structure. The semantic mask generated at step 810 may be the semantic mask 210 generated by the mask generation network 127 during the mask generation 205 of FIG. 3A.

In some instances, method 800 may include identifying a contextual image at step 815. That is, the contextual image identified at step 815 may be identified such that the contextual image has one or more textural features. The contextual image selected at step 815 may be the contextual image 220 selected by the context selection network 128 during the context selection 215 of FIG. 3A.

In some embodiments, method 800 includes applying augmentations at step 820. That is, applying augmentations at step 820 may include applying a mask augmentation (e.g., mask augmentations 212) to the semantic mask generated at step 810. Additionally or alternatively, applying the augmentations at step 820 may include applying an image augmentation (e.g., image augmentations 222) to the contextual image selected at step 815. In this way, as described above with reference to FIGS. 7A and 7B, the semantic mask and the contextual image may be manipulated according to patient anatomy, system parameters, user preferences, and so on.

Step 825 of method 800 includes generating a synthetic image based on the semantic mask generated at step 810 and the contextual image identified at step 815. That is, the synthetic image generated at step 825 is generated such that the synthetic image has the anatomical structure of the semantic mask generated at step 810 and the textural features of the contextual image identified at step 815. The synthetic image generated at step 825 may be the synthetic image 230 generated by the image generation network 129 during the image generation 225 of FIG. 3A.

Furthermore, where method 800 includes applying augmentations at step 820, the synthetic image may be generated at step 825 based on the applied augmentations (e.g., mask augmentations to the semantic mask, image augmentations to the contextual image).

The embodiments described herein have been described with reference to drawings. The drawings illustrate certain details of specific embodiments that provide the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As utilized herein, terms of degree such as “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to any precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that terms such as “exemplary,” “example,” and similar terms, as used herein to describe various embodiments, are intended to indicate that such embodiments are possible examples, representations, or illustrations of possible embodiments, and such terms are not intended to connote that such embodiments are necessarily extraordinary or superlative examples.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any element on its own or any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the drawings. It should be noted that the orientation of various elements may differ according to other exemplary embodiments, and that such variations are intended to be encompassed by the present disclosure.

As used herein, terms such as “engine” or “circuit” may include hardware and machine-readable media storing instructions thereon for configuring the hardware to execute the functions described herein. The engine or circuit may be embodied as one or more circuitry components including, but not limited to, processing circuitry, network interfaces, peripheral devices, input devices, output devices, sensors, etc. In some embodiments, the engine or circuit may take the form of one or more analog circuits, electronic circuits (e.g., integrated circuits (IC), discrete circuits, system on a chip (SOCs) circuits, etc.), telecommunication circuits, hybrid circuits, and any other type of circuit. In this regard, the engine or circuit may include any type of component for accomplishing or facilitating achievement of the operations described herein. For example, an engine or circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

An engine or circuit may be embodied as one or more processing circuits comprising one or more processors communicatively coupled to one or more memory or memory devices. In this regard, the one or more processors may execute instructions stored in the memory or may execute instructions otherwise accessible to the one or more processors. The one or more processors may be constructed in a manner sufficient to perform at least the operations described herein. In some embodiments, the one or more processors may be shared by multiple engines or circuits (e.g., engine A and engine B, or circuit A and circuit B, may comprise or otherwise share the same processor which, in some example embodiments, may execute instructions stored, or otherwise accessed, via different areas of memory).

Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be provided as one or more suitable processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given engine or circuit or components thereof may be disposed locally (e.g., as part of a local server, a local computing system, etc.) or remotely (e.g., as part of a remote server such as a cloud based server). To that end, engines or circuits as described herein may include components that are distributed across one or more locations.

An example system for providing the overall system or portions of the embodiments described herein might include one or more computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

Although the drawings may show and the description may describe a specific order and composition of method steps, the order of such steps may differ from what is depicted and described. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions, and arrangement of the embodiments without departing from the scope of the present disclosure as expressed in the appended claims.

What is claimed is:

1. A system comprising:
a processing circuit comprising a processor coupled to a memory device storing instructions thereon that, when executed, cause the processing circuit to perform operations comprising:
generating a semantic mask representing an anatomical structure;
identifying a contextual image having at least one textural feature; and
applying the semantic mask and the contextual image to an artificial intelligence model, wherein the artificial intelligence model is configured to generate a synthetic image having the anatomical structure and the at least one textural feature.

2. The system of claim 1, wherein the semantic mask is generated by a mask generation network, and wherein the mask generation network is trained using a plurality of mask images.

3. The system of claim 1, wherein the contextual image is identified by a context selection network, and wherein the context selection network is trained using natural images.

4. The system of claim 1, wherein the artificial intelligence model is a paired image translation diffusion model.

5. The system of claim 1, wherein the operations further comprise applying a mask augmentation to the semantic mask, and wherein the mask augmentation is based on a patient anatomy.

6. The system of claim 5, wherein the mask augmentation is configured to control geometrical properties of the semantic mask.

7. The system of claim 1, wherein the operations further comprise applying an image augmentation to the contextual image, and wherein the image augmentation is based on a system parameter.

8. The system of claim 7, wherein applying the image augmentation controls textural properties of the contextual image.

9. The system of claim 1, wherein the synthetic image represents a medical image that is obtained by at least one of a computed tomography imaging system, an ultrasound imaging system, a magnetic resonance imaging system, a positron emission tomography imaging system, or a single-photon emission computerized tomography imaging system.

10. A system comprising:
a mask generation network configured to generate a semantic mask representing an anatomical structure;
a context selection network configured to identify a contextual image having at least one textural feature; and
an image generation network configured to generate a synthetic image having the anatomical structure and the at least one textural feature.

11. The system of claim 10, wherein the context selection network is trained using natural images.

12. The system of claim 10, wherein the image generation network comprises a paired image translation diffusion model.

13. The system of claim 10, wherein the image generation network is configured to apply a mask augmentation to the semantic mask before generating the synthetic image, and wherein the mask augmentation is configured to control geometrical properties of the semantic mask.

14. The system of claim 10, wherein the image generation network is configured to apply an image augmentation to the contextual image before generating the synthetic image, and wherein the image augmentation is configured to control textural properties of the contextual image.

15. The system of claim 10, wherein the synthetic image represents a medical image that is obtained by at least one of a computed tomography imaging system, an ultrasound imaging system, a magnetic resonance imaging system, a positron emission tomography imaging system, or a single-photon emission computerized tomography imaging system.

16. A method comprising:
generating, by a mask generation network, a semantic mask representing an anatomical structure;
identifying, by a context selection network, a contextual image having at least one textural feature; and
generating, by an image generation network and in response to receiving the semantic mask and the contextual image as inputs, a synthetic image having the anatomical structure and the at least one textural feature.

17. The method of claim 16, wherein the method further comprises applying a mask augmentation to the semantic mask, and wherein the mask augmentation is based on a patient anatomy.

18. The method of claim 17, wherein the mask augmentation is configured to control at least one of a shape, a width, a size, or an image orientation of the semantic mask.

19. The method of claim 16, wherein the method further comprises applying an image augmentation to the contextual image, and wherein the image augmentation is based on a system parameter.

20. The method of claim 19, wherein applying the image augmentation controls at least one of a contrast, a granularity, or a brightness of the contextual image.
